(19) United States
(12) Patent Application Publication
(10) Pub. No.: US 2021/0374621 A1
(43) Pub. Date: Dec. 2, 2021

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Misaki MATSUZAWA, Kanagawa (JP)

(73) Assignee: FUJIFILM BUSINESS INNOVATION CORP., Tokyo (JP)

(21) Appl. No.: 17/115,234

(22) Filed: Dec. 8, 2020

(30) Foreign Application Priority Data
May 28, 2020 (JP) 2020-092969

(51) Int. Cl. G06Q 10/02; G06Q 30/06; G01C 21/36

(52) U.S. Cl. CPC G06Q 10/02; G01C 21/3697; G06Q 30/0645

(57) ABSTRACT

An information processing apparatus includes a processor configured to acquire information regarding status of spaces and information regarding booking status of each of the spaces, each of the spaces becoming available after being booked by a user, and present a location of each of the spaces on a map in a mode depending on status of the location of each of the spaces and the acquired booking status.

### CROSS-REFERENCE TO RELATED APPLICATIONS

This application is based on and claims priority under 35 USC 119 from Japanese Patent Application No. 2020-092969 filed May 28, 2020.

### BACKGROUND

### (i) Technical Field

The present disclosure relates to an information processing apparatus and a non-transitory computer readable medium.

### (ii) Related Art

Japanese Unexamined Patent Application Publication No. 2002-230124 describes a disclosure of an information service system that has a first service unit and a second service unit and that provides information requested by a customer who carries a personal digital assistant and shops at a store. While the personal digital assistant is on the way to the store and before reaching the store, the first service unit provides the personal digital assistant with map information and information regarding the store, and the map information indicates the current location of the personal digital assistant and a route to the store, the current location being detected by the personal digital assistant. The second service unit provides the personal digital assistant in the store with map information in the store and information regarding the store, and the map information in the store indicates the current location of the personal digital assistant in the store, the current location being detected by the personal digital assistant.

Japanese Unexamined Patent Application Publication No. 2012-194058 describes a disclosure of a navigating-to-destination system that can guide a user from the current location to a destination by using guides, guide information, a guide-extraction unit, and a presentation unit. Each guide is visible and is placed at a location from which or from the vicinity of which one or more other guides are visible. The guide information includes the information regarding the guide and the information regarding the one or more guides visible from the location or the vicinity of the location of the guide. The guide-extraction unit extracts a guide to which to proceed based on the current location, the destination, and the guide information. The presentation unit successively presents guides to which to proceed until the destination is reached.

Japanese Unexamined Patent Application Publication No. 2017-130029 describes a disclosure of an hourly rental system of accessible spaces. The hourly rental system of accessible spaces includes a user application and one or more accessible spaces provided by a provider. Each of the one or more accessible spaces has an identifying sign that can at least identify the accessible space. The user application obtains information from a database of an hourly rental enterprise and displays the information so that a user can retrieve the status of accessible spaces. The user application also includes a unit, which can accept a reservation for use from the user, change the usage status of the accessible spaces in the database of the hourly rental enterprise, navigate the user to a reserved accessible space, and check the arrival at and the departure from the reserved accessible space. In addition, in response to the status change, the user application updates the status of the accessible spaces to determine whether each of the accessible spaces is unreserved, reserved, or occupied. Further, the user application has a function of presenting a usage fee, a function of electronic settlement, and a notification service function that requests a user as necessary to report arrival and departure. The hourly rental enterprise, the provider of accessible spaces, and a user of accessible spaces can use the hourly rental system of accessible spaces by entering into a contract for provision and usage with each other.

### SUMMARY

Recent years have seen an increasing use of a sharing service in which a personal space is allowed to be occupied by each of a plurality of users in turn during a different period of time. Systems for booking a space in a sharing service already exist. But a user cannot recognize whether a booking target is located indoors or outdoors without changing settings of a map. Further, information regarding physical status of the booking target and various conditions of the booking target, such as the status of search and usage by other users, are not readily available from the information contained in the map.

Aspects of non-limiting embodiments of the present disclosure relate to providing an information processing apparatus and a non-transitory computer readable medium storing a program that enable a user to grasp the status of a booking target before use.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to acquire information regarding status of spaces and information regarding booking status of each of the spaces, each of the spaces becoming available after being booked by a user, and present a location of each of the spaces on a map in a mode depending on status of the location of each of the spaces and the acquired booking status.

### BRIEF DESCRIPTION OF THE DRAWINGS

An exemplary embodiment of the present disclosure will be described in detail based on the following figures, wherein:

FIG. 1 is an illustration depicting a schematic configuration of a sharing-service booking system according to the present exemplary embodiment;

FIG. 2 is a block diagram depicting a hardware configuration of a server;

FIG. 3 is a block diagram depicting an example of a functional configuration of the server;

FIG. 4 is a flowchart depicting a flow of a booking process performed by the server;

FIG. 5 is an illustration depicting an example of a user interface displayed by a user terminal;

FIG. 6 is an illustration depicting an example of a user interface displayed by the user terminal;

FIG. 7 is a flowchart depicting a flow of a guiding process performed by the server;

FIG. 8 is an illustration depicting an example of a user interface displayed by the user terminal;

FIG. 9 is an illustration depicting an example of a user interface displayed by the user terminal;

FIG. 10 is an illustration depicting an example of a user interface displayed by the user terminal;

FIG. 11 is an illustration depicting an example of a box-type space; and

FIG. 12 is an illustration depicting an example of a visual image shot by a surveillance camera.

### DETAILED DESCRIPTION

Hereinafter, an exemplary embodiment according to the present disclosure will be described with reference to the drawings. In the figures, the same or equivalent elements and parts are denoted by the same reference signs. The dimensions and proportions in the figures are emphasized for the sake of description and are not necessarily drawn to scale.

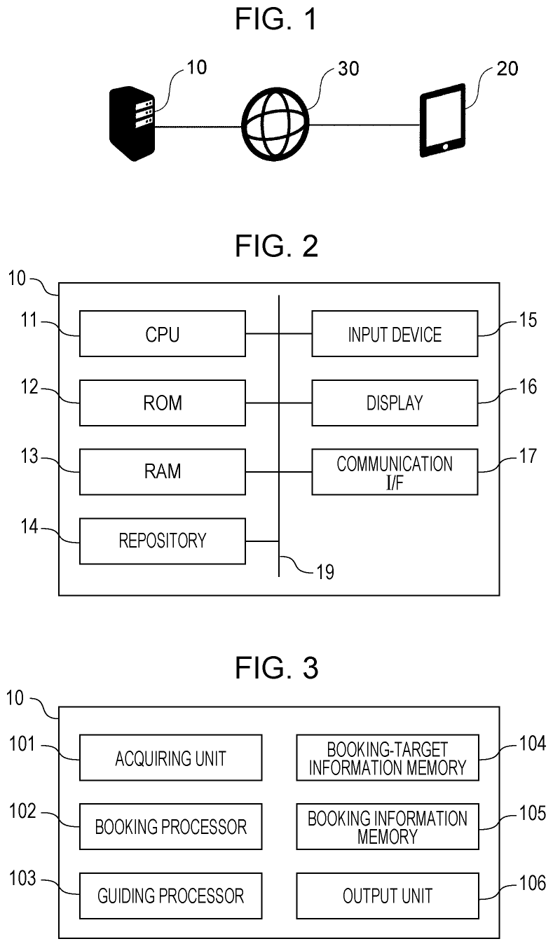

FIG. 1 is an illustration depicting a schematic configuration of a sharing-service booking system according to the present exemplary embodiment. As depicted in FIG. 1, the sharing-service booking system according to the present exemplary embodiment includes a server 10 and a user terminal 20. The server 10 accepts bookings in a sharing service in which a personal space is allowed to be occupied by each of a plurality of users in turn during a different period of time, and the user terminal 20 is used to access the server 10 to book a space. The server 10 and the user terminal 20 are communicatively connected to a network 30, such as the Internet.

A space to book in the sharing-service booking system according to the present exemplary embodiment may be a box-type space, which is completely surrounded by walls, a door, a ceiling, and the like, or an open-type space. An open-type space is only separated by partitions or the like and is not completely enclosed, or alternatively, has no partition separating each space. Examples of a space to book in the sharing-service booking system according to the present exemplary embodiment include various kinds of spaces, such as a workspace of a box type, a table in an eating place including a restaurant and a coffee shop, a conference room, a parking lot, and a bicycle rack. In the following description, a space to book in the sharing-service booking system is also referred to simply as a space.

The server 10, which is an example of an information processing apparatus, not only accepts a booking in a sharing service from the user terminal 20 but also provides the user terminal 20 with a guide to a booked location. As described below, when accepting a booking in the sharing service, the server 10 enables the user to grasp before use what the place that the user is going to book looks like. When presenting what the place that the user is going to book looks like, the server 10 provides presentation that is easy to grasp for the user. A description will be given below of a specific example of the presentation to the user terminal 20 by the server 10.

Examples of the user terminal 20 include a personal computer, a smartphone, and a tablet-type portable terminal. The user may use different user terminals as the user terminal 20 when booking a space in the sharing service and while heading for the booked location. If different user terminals are used as the user terminal 20, the user terminal that is used as the user terminal 20 while the user is heading for the booked location may be a device that can acquire and present the positional information of the current location.

In FIG. 1, a single server is depicted as the server 10, and a single user terminal is depicted as the user terminal 20. But neither the number of servers to operate as the server 10 nor the number of user terminals to operate as the user terminal 20 needs to be one.

FIG. 2 is a block diagram depicting a hardware configuration of the server 10.

As depicted in FIG. 2, the server 10 includes a central processing unit (CPU) 11, a read-only memory (ROM) 12, a random-access memory (RAM) 13, a repository 14, an input device 15, a display 16, and a communication interface (I/F) 17. These units are communicatively connected to each other by a bus 19.

The CPU 11, which is a central computing processing unit, executes various programs and controls each unit. Specifically, the CPU 11 loads programs from the ROM 12 or from the repository 14 and uses the RAM 13 as a working space to execute the programs. The CPU 11 controls each unit described above and performs various kinds of computing processing in accordance with the programs recorded on the ROM 12 or on the repository 14. In the present exemplary embodiment, the ROM 12 or the repository 14 stores a booking program that accepts a booking in the sharing service from the user terminal 20 and that provides the user with a guide to the booked location.

The ROM 12 stores various programs and various kinds of data. The RAM 13 operates as the working space and temporarily stores programs or data. A storage device such as a hard disk drive (HDD), a solid state drive (SSD), or a flash memory constitutes the repository 14, which stores various programs including the operating system and various kinds of data.

The input device 15 includes a pointing device, such as a mouse, and a keyboard and is used for receiving various kinds of input.

The display 16 is, for example, a liquid crystal display and displays various kinds of information. The display 16 may adopt a touch panel system and may also function as the input device 15.

The communication interface 17 is an interface for communicating with other apparatuses, such as the user terminal 20, and such a standard as the Ethernet (registered trademark), fiber distributed data interface (FDDI), or Wi-Fi (registered trademark) is used.

While executing the booking program above, the server 10 uses the hardware resources described above and realizes various functions. A functional configuration realized by the server 10 will be described.

FIG. 3 is a block diagram depicting an example of the functional configuration of the server 10.

As depicted in FIG. 3, the server 10 includes an acquiring unit 101, a booking processor 102, a guiding processor 103, a booking-target information memory 104, a booking information memory 105, and an output unit 106 as functional sections. Each functional section is realized by the CPU 11, which loads and executes the booking program stored in the ROM 12 or in the repository 14.

The acquiring unit 101 acquires various kinds of information. For example, the acquiring unit 101 acquires a booking input from the user terminal 20. In addition, for example, the acquiring unit 101 acquires from the booking-target information memory 104 and the booking information memory 105 information necessary for a booking process and a guiding process that leads to the booked location.

The booking processor 102 processes a booking for a space in response to the booking input from the user terminal 20. Detailed description of a booking process for a space will be given below.

In accordance with booking information stored in the booking information memory 105, the guiding processor 103 performs a guiding process leading to the space booked by the user. Detailed description of the guiding process leading to the space booked by the user will be given below.

The booking-target information memory 104 stores information regarding spaces to be booked by users. The booking-target information memory 104 can store as the information regarding spaces such information as locations of spaces, whether spaces are located indoors or outdoors, floor levels, types, specified directions, available languages, and installed devices. Examples of the type of a space can include a box type and an open type that only separates an area by using partitions. The specified direction of a space is a direction specified by an enterprise that provides the space and, for example, can be a direction in which a user faces when seated on the chair behind the desk installed in the space. Each of the available languages can be a language in which a user manual placed in the space is written.

The booking information memory 105 stores booking information regarding spaces that have been booked by users. The booking information memory 105 can store as the booking information such information as booked spaces, users who have booked spaces, dates and times of use, duration of use, and account-adjustment-related information regarding settlement and adjustment for the use of booked locations.

The output unit 106 outputs various kinds of information. For example, the output unit 106 outputs to the user terminal 20 a result of the booking process performed by the booking processor 102 and a result of the guiding process performed by the guiding processor 103.

Next, an operation of the server 10 will be described.

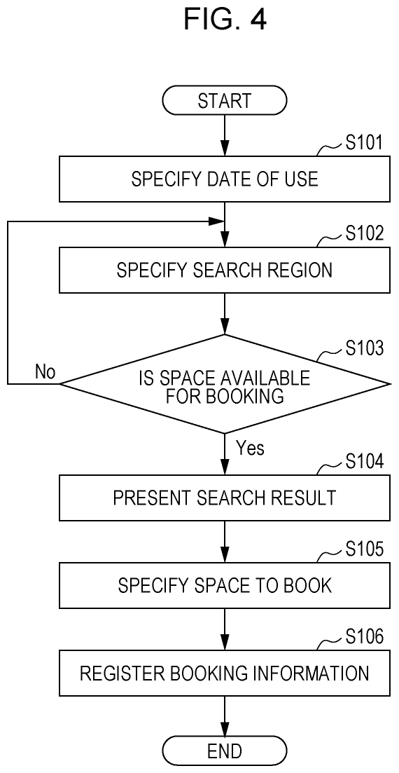

First, the booking process, which is performed by the server 10, will be described. FIG. 4 is a flowchart depicting a flow of the booking process performed by the server 10. The CPU 11 reads the booking program stored in the ROM 12 or in the repository 14 and loads the booking program onto the RAM 13 to execute the program, and then the booking process is performed.

The CPU 11 accepts a specification of a date of use from the user terminal 20 (step S101). Following step S101, the CPU 11 accepts a specification of a search region from the user terminal 20 (step S102).

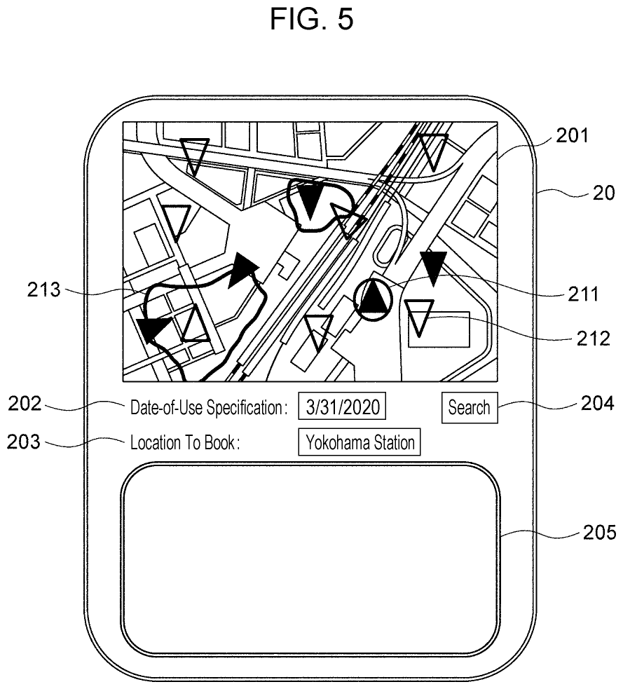

FIG. 5 is an illustration depicting an example of a user interface displayed by the user terminal 20. A map 201 presents an area that includes a space to be booked by a user and the neighborhood of the space. The scale of the map 201 may be changed by a user operation. A date-of-use specification box 202 is used by the user to input a date of use of a space to book. A location-to-book box 203 is used by the user to input a location used as a guide in the neighborhood of the space to book. A search button 204 is used to designate as a search condition the date that is input into the date-of-use specification box 202 and the location that is input into the location-to-book box 203 and cause the server 10 to search for a space that meets the search condition. In the example in FIG. 5, the server 10 is caused to search for a space that is available on Mar. 31, 2020 near Yokohama station. An information presentation box 205 is used to present various kinds of information. As described below, various kinds of information are presented in the information presentation box 205 during the booking process and during the guiding process.

The symbol 211 indicates the current position of the user terminal 20. The current position of the user terminal 20 can be determined by using a satellite positioning system, such as the Global Positioning System (GPS), or a positioning system using locations of base stations of cellular communications or base units of wireless local area networks (LAN).

The symbol 212 is a marker to indicate a location of a space provided by a sharing service near the location that has been input into the location-to-book box 203. In FIG. 5, isosceles triangles are used as markers, and each of the isosceles triangles indicates a location of a space. In the present exemplary embodiment, the direction that the vertex of an isosceles triangle faces indicates the direction specified in the sharing service. For example, if the direction that a user faces when seated on a chair behind a desk is the north, the vertex of an isosceles triangle faces the north.

In addition, in the present exemplary embodiment, the color of the frame of an isosceles triangle indicates the status of a space. For example, a green frame indicates an overbooked space, a red frame indicates a booked space, a blue frame indicates a space available for booking, and a black frame indicates that another user is booking the space now. The CPU 11 monitors usage status based on booking information and account-adjustment-related information and determines whether a space is overbooked in accordance with the difference between the time of use and the usage status.

In addition, in the present exemplary embodiment, an isosceles triangle is either filled or open and indicates whether a space is located in an outdoor area or in an indoor or underground area. For example, a filled isosceles triangle may indicate a space located outdoors, and an open isosceles triangle may indicate a space located indoors. The CPU 11 distinguishes between a space located indoors and a space located outdoors in accordance with whether information regarding a floor level is registered in the booking-target information memory 104. Specifically, the CPU 11 determines that a space is located in an indoor or underground area if a floor level is registered and determines that a space is located in an outdoor area if a floor level is not registered.

In FIG. 5, the direction that the vertex of an isosceles triangle faces indicates the direction of a space, but the present disclosure is not limited to this example. Characters, such as N and S, which indicates a direction, may be added to the map 201 to indicate the direction of a space.

The symbol 213 indicates a region specified by a user. As depicted in FIG. 5, a user may specify a region on the map 201 by using a finger or the like to define a region to be searched. The CPU 11 determines that the region indicated by the symbol 213 has been specified by the user.

Following step S102, the CPU 11 determines whether a space is available for booking in the region specified by the user (step S103).

If it is determined in step S103 that no space is available for booking in the region specified by the user (No in step S103), the CPU 11 accepts a specification of another search region from the user terminal 20.

In contrast, if it is determined in step S103 that at least one space is available for booking in the region specified by the user (Yes in step S103), the CPU 11 presents the search result to the user terminal 20 (step S104).

If the user specifies a space to book by using the user terminal 20 after the search result is presented to the user terminal 20 (step S105), the CPU 11 processes a booking for the specified space to book and registers booking information in the booking information memory 105 (step S106).

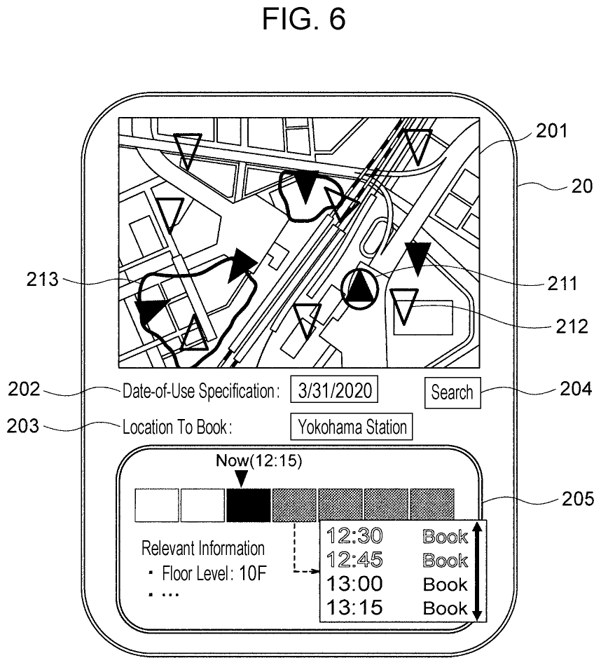

FIG. 6 is an illustration depicting an example of a user interface displayed by the user terminal 20 when a user books a space. In the example depicted in FIG. 6, the information presentation box 205 presents booking information regarding spaces that are available for booking and that are located in the region specified by the user. The region is specified in the bottom left-hand corner of the map 201. In addition, in the example depicted in FIG. 6, the information presentation box 205 presents basic information regarding a space available for booking, such as a floor level. The user selects an available time slot and can book the selected space.

The CPU 11 can display operation status of other users on the map 201 by changing marker presentation in conjunction with session information of each user managed by the CPU 11. In addition, the CPU 11 restricts operations by a plurality of users and prevents simultaneous operations by the plurality of users, so that a system error can be avoided.

A certain amount of time lag between the timing of incorporation of session information into a map and the timing of a user operation is generated, and thus users may simultaneously perform operations. In such a case, the CPU 11 may automatically propose to a user who started a booking operation later a space located near the original location in which the user tried to find a space to book. The user may be allowed to change a distance setting that defines the neighborhood around the original location in this case.

When presenting locations of spaces on the map 201, the CPU 11 may use information specific to the user terminal 20 and restrict locations that is presented. For example, if the user terminal 20 has been shipped with a restriction on the location of use, the CPU 11 may use the information regarding the location of use to identify the language that is likely to be used by the user and may present on the map 201 only locations of restricted spaces in which the language can be used.

When presenting locations of spaces on the map 201, the CPU 11 may also use user attribute information registered in the sharing-service booking system and restrict information that is presented. For example, if a user needs to care about the direction of a space because of a religious reason or the like, the CPU 11 may present the location of each space on the map 201 in a mode that includes the direction of the space. In contrast, the CPU 11 may present the location of each space on the map 201 in a mode that does not include the direction of the space for a user who does not need to care about the direction of the space.

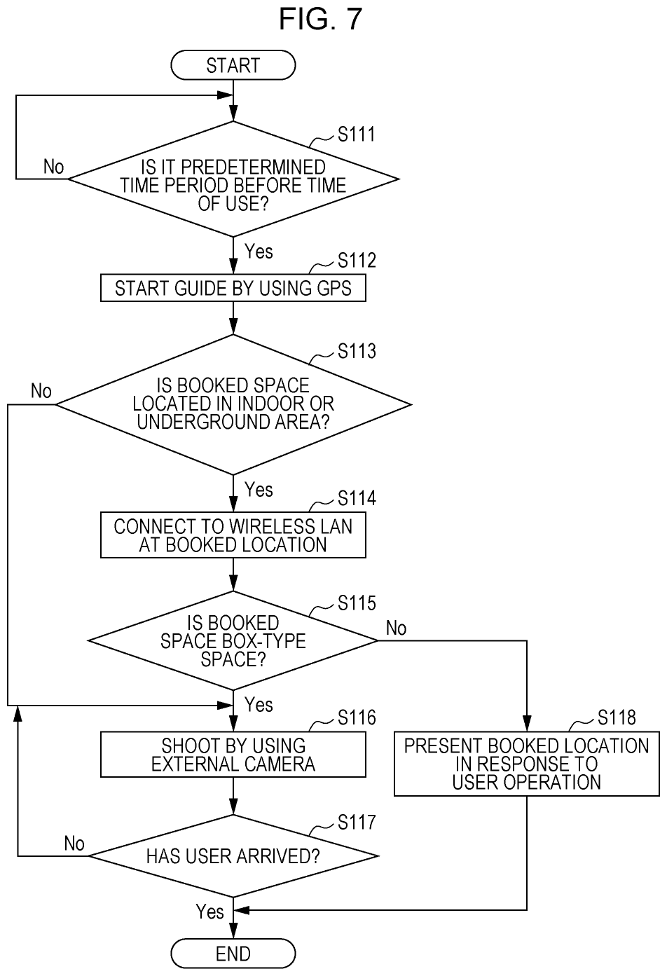

Next, the guiding process, which is performed by the server 10 and leads to a booked location, will be described. FIG. 7 is a flowchart depicting a flow of the guiding process performed by the server 10. The CPU 11 reads the booking program stored in the ROM 12 or in the repository 14 and loads the booking program onto the RAM 13 to execute the program, and then the guiding process is performed.

The CPU 11 refers to booking information stored in the booking information memory 105 and waits until a predetermined time period before the time of use of a space booked by a user (step S111). For example, the CPU 11 waits until 10 minutes before the time of use of the space.

At the predetermined time period before the time of use of the space booked by the user (Yes in step S111), the CPU 11 uses a satellite positioning system, such as the GPS, (or a positioning system using locations of base stations of cellular communications) and starts a guide by using the user terminal 20, which is used by the user (step S112). At the predetermined time period before the time of use, the CPU 11 may report to the user terminal 20 that the time of use is approaching.

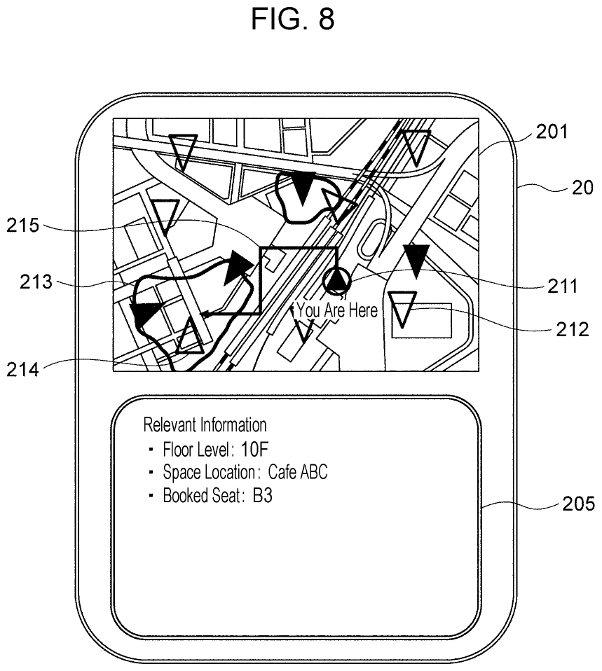

FIG. 8 is an illustration depicting an example of a user interface displayed by the user terminal 20 while the user is guided to the booked location. In the example depicted in FIG. 8, a route 215 to a marker 214 that indicates the booked location is presented on the map 201. In addition, in the example depicted in FIG. 8, the information presentation box 205 presents information regarding the space booked by the user.

Then, the CPU 11 determines whether the space booked by the user is located in an indoor or underground area (step S113). The CPU 11 refers to information stored in the booking-target information memory 104 and determines whether the space is located in an indoor or underground area. If it is determined in step S113 that the space booked by the user is located in an indoor or underground area (Yes in step S113), the CPU 11 allows the user terminal 20 to connect to the wireless LAN at the booked location (step S114). For example, the CPU 11 may transmit to the user terminal 20 the settings such as a service set identifier (SSID) and an encryption key, which are used to connect to the wireless LAN at the booked location.

Following step S114, the CPU 11 determines whether the space booked by the user is a box-type space (step S115). The CPU 11 refers to information stored in the booking-target information memory 104 and determines whether the space booked by the user is a box-type space.

If it is determined in step S115 that the space booked by the user is a box-type space (Yes in step S115), the CPU 11 causes an external camera to shoot the surroundings of the space. The external camera is installed at the space booked by the user or located in the neighborhood of the space (step S116). If it is determined in step S113 that the space booked by the user is not located in an indoor or underground area (No in step S113), the CPU 11 also causes an external camera, which is installed at the space booked by the user or located in the neighborhood of the space, to shoot the surroundings of the space. A visual image shot by the external camera is transmitted to the user terminal 20, which is connected to the wireless LAN at the booked location. The CPU 11 may perform image recognition on the visual image shot by the external camera and may transmit to the user terminal 20 the visual image modified in a mode that emphasizes characters and the like.

Following step S116, the CPU 11 determines whether the user has arrived at the booked location. Specifically, the CPU 11 uses a visual image shot by the external camera and determines whether the user has been able to recognize the booked location (step S117). It may be determined whether the user has been able to recognize the booked location in accordance with whether the user has operated the user terminal 20 to transmit to the server 10 a message saying that no further guide is necessary or whether the server 10 has recognized that the user unlocks the space at the booked location. Further, it may be determined whether the user has been able to recognize the booked location in accordance with whether a face of a size equal to or larger than a predetermined value can be recognized in the visual image shot by the external camera.

If it is determined in step S117 that the user has not arrived at the booked location (No in step S117), the CPU 11 causes the external camera to continue shooting. In contrast, if the user has arrived at the booked location (Yes in step S117), the CPU 11 causes the external camera to stop shooting and finishes the guide for the user. In this way, since the visual image shot by the external camera is transmitted to the user terminal 20 and is displayed by the user terminal 20, even a person who is unfamiliar with the location or a foreign tourist who does not understand the language can efficiently be guided to the booked location.

In contrast, if it is determined in step S115 described above that the space booked by the user is not a box-type space (No in step S115), the CPU 11 causes the user terminal 20 to present the booked location in response to the operation of the user terminal 20 by the user (step S118). For example, the user causes the user terminal 20 to read a marker containing information regarding a store map (such as a two-dimensional code, an augmented reality (AR) marker, and a bulletin board presenting a store map). The CPU 11 may check the store map against space information stored in the booking-target information memory 104 and thus may emphasize only the booked location for presentation to the user terminal 20. The CPU 11 can present the booked seat to the user in an easily recognizable manner by emphasizing only the booked location for presentation to the user terminal 20. In addition, in response to access from a web browser of the user terminal 20, the CPU 11 may use a web AR technology and cause the web browser of the user terminal 20 to present a marker on the booked seat by using a space recognition technology based on the GPS.

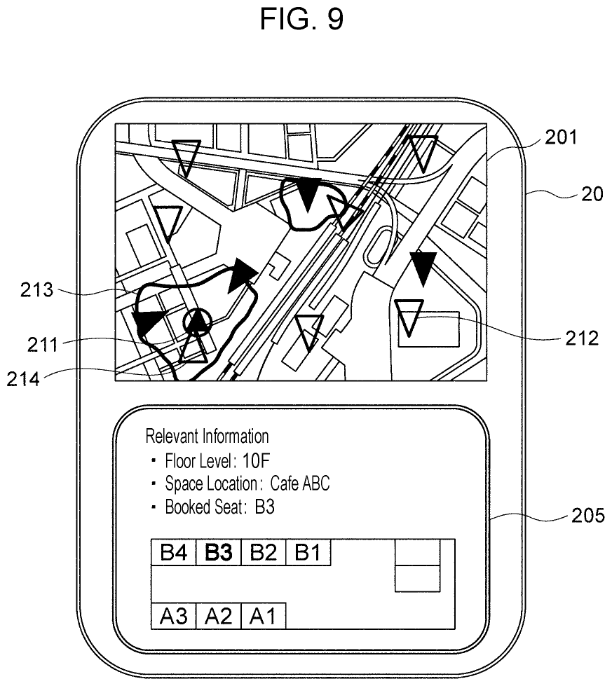

FIG. 9 is an illustration depicting an example of a user interface displayed by the user terminal 20 while a user is guided to a booked location. In the example depicted in FIG. 9, the information presentation box 205 presents a store map and the location of the space booked by the user. If the store has a plurality of tables, the CPU 11 can present the booked seat to the user in an easily recognizable manner by emphasizing only the booked location for presentation to the user terminal 20.

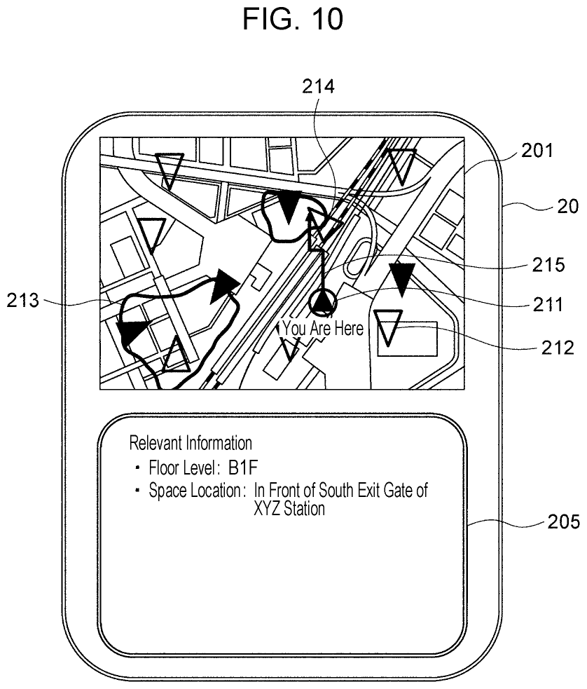

FIG. 10 is an illustration depicting an example of a user interface displayed by the user terminal 20 while a user is guided to a booked location. FIG. 10 depicts a guide to the booked location in the case of a booked space being located underground. In the example depicted in FIG. 10, a route 215 to a marker 214 that indicates the booked location is also presented on the map 201. As described above, if the booked space is located underground, the CPU 11 causes the external camera installed at the booked space or located in the neighborhood of the space to shoot the surroundings of the space.

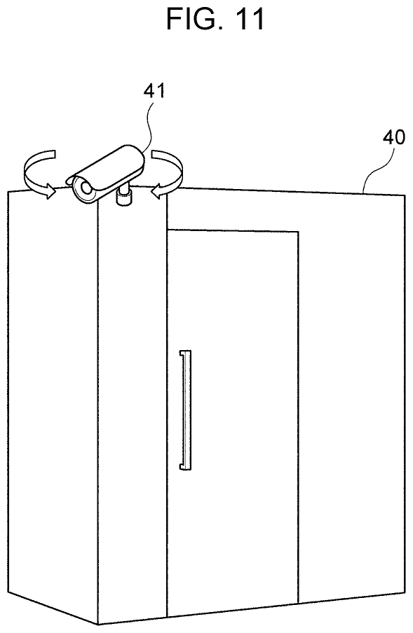

FIG. 11 is an illustration depicting an example of a space to book. FIG. 11 depicts as a space to book a workspace 40 that is a box-type space. The workspace 40 is equipped with a surveillance camera 41, which is an example of an external camera. The CPU 11 allows the user terminal 20 to connect to the wireless LAN installed at the workspace 40 and transmits a visual image shot by the surveillance camera 41 to the user terminal 20. The CPU 11 causes the user terminal 20 to display the visual image shot by the surveillance camera 41 and thus enables a user to grasp the surroundings of the workspace 40 and arrive at the space in the workspace 40 with ease.

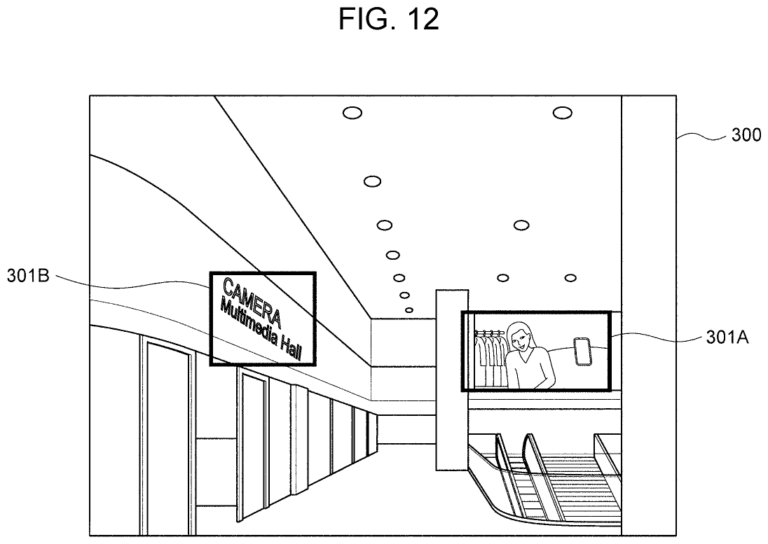

FIG. 12 is an illustration depicting an example of a visual image shot by the surveillance camera 41. A visual image 300 in FIG. 12 is shot by the surveillance camera 41 facing one direction and is transmitted to the user terminal 20. The CPU 11 may perform image processing such as character recognition and image recognition on the visual image 300 and may emphasize characters or images that have been recognized. The symbol 301A in FIG. 12 indicates a frame enclosing a region recognized by image recognition, and the symbol 301B indicates a frame enclosing a region recognized by character recognition. The CPU 11 may use character recognition to recognize the name of a store located in the neighborhood of the space and report the recognized location to the user terminal 20. In this way, the CPU 11 emphasizes characters or images that have been recognized and transmits the characters or images to the user terminal 20, and thus the user can grasp the surroundings of the workspace 40 more easily than in the case where the visual image 300 is simply transmitted to the user terminal 20.

The CPU 11 may allow the surveillance camera 41 to be controlled via the wireless LAN installed at the workspace 40 by using the user terminal 20. For example, the CPU 11 may allow the surveillance camera 41 to be controlled for a limited amount of time, for example, before the time of use or may allow the surveillance camera 41 to be controlled for restricted shooting directions. In addition, if the surveillance camera 41 is controlled by using the user terminal 20, the CPU 11 may allow the surveillance camera 41 to keep shooting at a height of a human face. Further, if a plurality of cameras are installed as the surveillance camera 41, the CPU 11 may allow all of the plurality of cameras to be controlled by using the user terminal 20. Alternatively, the CPU 11 may prohibit at least one of the plurality of cameras from being controlled by using the user terminal 20 and allow the rest of the plurality of cameras to be controlled by using the user terminal 20. The CPU 11 may cause the direction of the surveillance camera 41 to return to a predetermined direction after the user has been guided.

In the present exemplary embodiment, information is presented in a mode based on the status of the location of a space to book and the booking status of the space to book, and thus the user is allowed to grasp the status of the space to book before use. Further, in the present exemplary embodiment, if a user performs a booking operation and determines to book a space, which has been booked by another user during the booking operation of the user, a space at a different location can be proposed. Further, in the present exemplary embodiment, a booking system and a guiding system are provided on the single server 10, and thus the user does not need to run different applications on the user terminal 20. Further, in the present exemplary embodiment, if a space to book, such as a parking lot or a store, is located in an indoor or underground area, where an electromagnetic wave from a satellite positioning system such as the GPS cannot be received, the user can be guided to the destination by using information such as a visual image shot by a camera.

In the exemplary embodiments described above, the CPU loads software (a program) and executes the booking process and the guiding process, but the booking process and the guiding process may be executed by various processors other than the CPU. Examples of such a processor include a programmable logic device (PLD), such as a field-programmable gate array (FPGA), whose circuit configuration is modifiable after fabrication, and a dedicated electric circuit, such as an application-specific integrated circuit (ASIC), which is a processor having a circuit configuration exclusively designed to execute a specific process. Further, the booking process and the guiding process may be performed by using one of the various processors described above or by using a combination of two or more similar or dissimilar processors (for example, a combination of a plurality of FPGAs or a combination of a CPU and an FPGA). More specifically, the hardware structure of these various processors is an electric circuit formed by a combination of circuit elements such as semiconductor devices.

Further, in the above exemplary embodiments, a situation in which the program for the booking process and the guiding process is stored (installed) in the ROM or in the repository in advance has been described by way of non-limiting example. The program may be recorded on a non-transitory recording medium and provided. Examples of the non-transitory recording medium include a compact disc read-only memory (CD-ROM), a digital versatile disc read-only memory (DVD-ROM), and a universal serial bus (USB) memory. Alternatively, the program may be downloaded from an external apparatus via a network.

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
acquire information regarding status of spaces and information regarding booking status of each of the spaces, each of the spaces becoming available after being booked by a user, and
present a location of each of the spaces on a map in a mode depending on status of the location of each of the spaces and the acquired booking status.

2. The information processing apparatus according to claim 1,
wherein the processor is configured to express an installation direction of each of the spaces in a mode depending on physical status of the location of the space and present the installation direction of the space on the map.

3. The information processing apparatus according to claim 2,
wherein a desk is installed in the space, a direction toward the desk is specified, and the processor is configured to present on the map the specified direction as the installation direction of the space.

4. The information processing apparatus according to claim 2,
wherein the processor is configured to present the location of each of the spaces on the map in a mode that indicates the installation direction of the space in accordance with a setting to present the installation direction of the space on the map.

5. The information processing apparatus according to claim 1,
wherein the processor is configured to present the location of each of the spaces on the map in a mode that can distinguish the location situated indoors and the location situated outdoors.

6. The information processing apparatus according to claim 1,
wherein the processor is configured to present the location of each of the spaces on the map in a mode that makes a floor level of the location recognizable.

7. The information processing apparatus according to claim 1,
wherein the processor is configured to make a booking for one of the spaces in response to a booking operation by the user and perform a process to guide the user to the booked space by using the map.

8. The information processing apparatus according to claim 7,
wherein the processor is configured to present a placement layout of the one of the spaces together with the map in response to shooting of a predetermined marker by a user.

9. The information processing apparatus according to claim 7,
wherein the processor is configured to present together with the map a visual image obtained from a camera that is installed so as to shoot the one of the spaces or surroundings of the one of the spaces.

10. The information processing apparatus according to claim 9,
wherein the processor is configured to change a shooting direction of the camera in response to control by the user to operate the camera.

11. The information processing apparatus according to claim 10,
wherein the processor is configured to change the shooting direction of the camera in a range that enables shooting at a height of a human face.

12. The information processing apparatus according to claim 7,
wherein the processor is configured to present a candidate space that is located near the one of the spaces and that can be booked if the booking for the one of the spaces cannot be made in response to the booking operation by the user.

13. The information processing apparatus according to claim 1,
wherein the processor is configured to present the booking status on the map whenever necessary based on session information obtained from each user.

14. A non-transitory computer readable medium storing a program causing a computer to execute a process for information processing, the process comprising:
acquiring information regarding status of spaces and information regarding booking status of each of the spaces, each of the spaces becoming available after being booked by a user; and
presenting a location of each of the spaces on a map in a mode depending on status of the location of each of the spaces and the acquired booking status.

15. An information processing apparatus comprising:
means for acquiring information regarding status of spaces and information regarding booking status of each of the spaces, each of the spaces becoming available after being booked by a user; and
means for presenting a location of each of the spaces on a map in a mode depending on status of the location of each of the spaces and the acquired booking status.
